(19) United States
(12) Patent Application Publication
(10) Pub. No.: US 2002/0169672 A1
(43) Pub. Date: Nov. 14, 2002

(54) System and method for attracting online viewers through distribution of hidden-award substrates redeemable at an online site

(76) Inventor: Thomas L. Barnhart, Atlanta, GA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/155,174

(22) Filed: May 28, 2002

Related U.S. Application Data
(63) Continuation of application No. 09/517,061, filed on Mar. 1, 2000, now abandoned.
Application No. 09/517,061 is a continuation-in-part of application No. 09/437,254, filed on Nov. 10, 1999, now Pat. No. 6,296,900.
Application No. 09/437,254 is a continuation of application No. 09/081,795, filed on May 20, 1998, now Pat. No. 5,984,367.
(60) Provisional application No. 60/183,147, filed on Feb. 17, 2000.

(51) Int. Cl. G06F 17/60

(52) U.S. Cl. 705/14

(57) ABSTRACT

A system and method for attracting visitors to an online site through use of a hidden-award substrate. In particular, a system and method of distributing substrates containing a hidden image to a plurality of offline content recipients is disclosed. The hidden image may be revealed by placing the substrate in front of a revealing screen, such as a portion of a web page. To either review the revealing screen, accept the award or redeem the award, the user may be requested to input visitor information including a unique account number associated with the substrate as well as other user identifying information to enable the system to determine the effectiveness of the distribution of these devices. The system may develop and manage risk and reward sharing agreements, including a back-end revenue model in which the online content providers may pay based on the number of offline content receivers that actually visit an online destination.

Patent

### FIELD OF THE INVENTION

The present invention relates to a system and method for attracting visitors to online systems by distributing a hidden award substrate whereby the hidden award is revealed to the user when the user visits the online system and views the substrate with a predetermined additive light source presented by the online system. The award is then redeemable at the online system when the user inputs a unique account number associated with the substrate.

### BACKGROUND OF THE INVENTION

Different systems and methods have been used in order to attract visitors to particular web sites and other online systems. Often, these methods have involved distribution of large amounts of advertising material involving a plurality of different online and offline media providers. For example, a web site may procure offline advertising slots in a magazine, a newspaper, a television, or other offline content source. It is estimated that web sites spent $2 billion in 1999 for offline advertising attempting to attract visitors to its sites.

The effectiveness of the advertisement, however, may be difficult to determine if the web site has a plurality of different advertising campaigns running simultaneously. Specifically, unless visitors indicate where they learned about the web site, the web site is unable to determine which of the offline media is most effective. Furthermore, because prospects are inundated with advertising, it is often difficult to capture a prospect's attention. Also, due to the vast amount of advertisements for web sites, prospects may fail to remember the name of the site. These web sites thus spend large amounts of money attempting to create name recognition for their web site so prospects become visitors and visitors become frequent and repeat visitors.

These and other drawbacks exist with current methods and systems.

### SUMMARY OF THE INVENTION

An object according to the present invention is to overcome these and other drawbacks with existing systems.

It is an object of the present invention to provide an engaging and interactive method of transforming prospects into online content viewers and consumers.

It is another object of the present invention to provide an economically efficient method of acquiring new online viewers and consumers by apportioning the risks and rewards between intermediaries and content provides in order to optimize performance of each of the entities.

It is another object of the present invention to apportion the costs and benefits associated with presenting hidden award indicating substrates to prospects and transforming those prospects into online viewers to optimize the strengths of each system participant and to provide each system participant sufficient incentives to achieve mutually beneficial objectives.

It is another object of the present invention to provide a method of attracting visitors to an online site repeatedly according to a predetermined schedule by offering awards that are indicated according to that predetermined schedule and that may be claimed when a recipient visits the online site according to the predetermined schedule.

It is another object of the present invention to provide a method for developing offline to online technology systems.

It is another object of the present invention to track and evaluate the effectiveness of various offline media distribution channels for a particular online system.

It is another object of the present invention to provide a system and method that records visitor information and visit information when a recipient of a hidden award substrate visits a web site to enhance the detail in an analysis of the effectiveness of various offline media distribution channels.

According to one embodiment, an offline content provider may enter an agreement with an online content provider in which the offline content provider includes hidden award substrates in its media. The hidden award substrates include one or more hidden image(s) and a unique account number. The recipient is directed to an online content provider such as by a web address provided on the substrate or published in the offline media through which the substrate is distributed. The recipient may also be informed of a possible or guaranteed award that is determined when the recipient visits the online content provider, displays the substrate at the online provider's web site to reveal the award, and inputs the unique account number to claim the award. For example, one or more of the hidden image(s) may be revealed when the recipient visits a predetermined web address of the online content provider and places the substrate in front of a predetermined part of a web page or online document. The unique account number may be input prior to enabling the visitor to access the portion of the online content provider site that reveals the hidden image or after the hidden image has been revealed.

According to another embodiment, multiple hidden images may be included on a substrate. In this embodiment, a visitor may be directed to different pages within a single web site or different sites altogether to determine the award(s) associated with the hidden image(s). In such instances, the costs and benefits derived from the visitation by the visitor to the various pages and/or sites may be allocated according to a predetermined arrangement, including a pro rata share of the costs based on the pages or sites visited by the visitor. For example, if distribution of the substrates costs $0.03 per substrate and three images are presented for three different web sites, then each site may be required to pay $0.01 apiece for the substrate distribution.

According to another embodiment, the hidden image(s) on a substrate may correspond to different awards at a plurality of different online content providers. The costs and benefits of this embodiment may be shared between the online providers. One or more hub sites may be provided where a recipient of the substrate is initially directed and that hub site may indicate awards available through that substrate at a plurality of other sites. For example, a recipient may visit the hub site and be informed that the substrate is good for $10 off of a purchase at one web site, a year's free subscription to a magazine through another, or a free mobile telephone from another site.

Also, a recipient may be directed to an online provider where a redeemable award is presented when the substrate is presented and the unique account number input. That online provider may then inform the recipient that an award may also be available at a second online provider. This may continue in a web-ring, web-mesh, or similar types of arrangements whereby the recipient is directed along a chain of web sites where the substrate may be good for one or more awards. The costs and benefits may then be split between the sites in the ring, mesh, or other participants according to a predetermined arrangement.

According to another embodiment of the present invention, the system and method may also present a predetermined award schedule to the recipient of the substrate. The system may modify the awards associated with a particular hidden image and/or unique account number periodically (e.g., hourly, daily, weekly, monthly, etc or randomly). The recipient of the substrate may be informed that the award may change either randomly or according to a predetermined schedule. Thereby, the recipient is encouraged to visit frequently and regularly to determine the award corresponding to the substrate. Through this additionally methodology, an online content provider attracts visitors to its site to introduce the visitor to the site and additionally provides incentive for the visitor to return to the site to thereby increase the number of hits to the site and increase the likelihood of leveraging that visitor into a consumer of the online content offered. If the awards are changed according to a schedule

According to another embodiment of the invention, a system is provided in which different distribution channels may be used to distribute the substrates including newspapers, mailers, handouts, consumer product packages, and other such distribution channels. The unique account numbers for the substrates are recorded with the method of distribution. When recipients visit online content providers associated with a substrate, the system may analyze the effectiveness of a particular distribution channel. Also, the system may receive input from the visitor including visitor information provided by the visitor and visit information that is automatically tracked based on the visitor's visit. With that information, specific and detailed tracking information may be provided about what distribution channels are effective for which online sites, what distribution channels are effective for which types of visitors, what distribution channels are effective at bringing consumers, what distribution channels are effective for various regions, demographics, age groups, financial backgrounds, etc. The analysis that is performed is only limited by the information collected and one of ordinary skill in the art should appreciate the various types of analysis that may be performed with the distribution information, visitor information and visit information.

According to another embodiment of the present invention, a system and method for distributing revenue and costs amongst participants in a hidden-award substrate distribution system may be provided. In that method, various arrangements may be made between the participants. The fees paid may be flat fees between various participants (including a system in which the flat fee changes according to various criteria), may be based on a percentage of visitors, consumers, or registrants generated to an online site, may be based on a percentage of revenue generated at an online site from the recipient of the substrate, may be based on the number of hits to an online site, may be based on the number of unique visitors or any other method of allocating revenue between participants. Further, it should be appreciated that the allocation methods may vary between different participants. For example, the substrate manufacturer may be paid per substrate, but the distributor may be paid per unique visitor to the online site for which the substrate is distributed.

According to another embodiment of the invention, an offline to online technology development company, or development company, may develop technology for converting prospects to online viewers. The development company may engage an intermediary that is familiar with the offline and online content providers in a particular industry in order to uniquely tailor the technology to the needs of the industry. The development company may develop the software and hardware systems needed to manage the compensation agreements that are developed between the development company and the intermediary and between the intermediary and the content distributors. In one embodiment, the development company may make the substrates having a hidden image indicative of an award at an online provider and the intermediary may oversee distribution of the substrates through offline media and contract with online providers to have the substrates created to direct visitors to the online provider sites. As discussed above, these participants may allocate the costs and benefits according to predetermined fee sharing arrangements.

Other objects and advantages of the present invention will be apparent to one of ordinary skill in the art upon reviewing the specification herein.

### BRIEF DESCRIPTION OF THE DRAWINGS

FIG. 1 depicts a method of attracting visitors to an online content provider through the distribution of hidden award substrates according to an embodiment of the present invention.

FIG. 2 depicts a method of attracting visitors to an online content provider through distribution of hidden award substrates that are redeemable at one or more specified online content providers through entry of a unique account number associated with the substrate according to an embodiment of the present invention.

FIG. 3 is a block diagram depicting relationships between an intermediary, content providers, and prospects according to an embodiment of the present invention.

FIG. 4 is a flow chart relating to a revenue model in accordance with an embodiment of the present invention.

FIG. 5 is a block diagram representing the relationships between an offline to online technology development company and a plurality of intermediaries.

FIG. 6 depicts a flow diagram of a method of sharing revenue between a plurality of participating online content providers in a hidden award substrate distribution method according to an embodiment of the present invention.

FIG. 7 depicts a flow diagram of a method of sharing revenue between a plurality of participating online content providers in a hidden award substrate distribution method according to another embodiment of the present invention.

FIG. 8 depicts a flow diagram of a method of attracting a visitor to visit an online system according to a predetermined schedule according to an embodiment of the present invention.

FIG. 9 depicts a flow diagram of a method of determining the effectiveness of various offline distribution avenues for attracting visitors to online content according to an embodiment of the present invention.

### DETAILED DESCRIPTION OF EMBODIMENTS OF THE PRESENT INVENTION

The present invention provides a system and method in which offline media may be used to attract visitors to online systems. For purposes of illustration, a specific embodiment of the present invention is described. In this embodiment, a substrate having a hidden image and a unique account number may be distributed using offline media (e.g., newspapers, magazines, handouts, fliers, mailings, enclosures on other products, etc.). The substrate may comprise a hidden image game piece as described in detail in U.S. Pat. No. 5,984,357 which is hereby incorporated by reference in its entirety. The substrate may be made by an offline to online enterprise that makes the substrates based on an agreement with a particular Internet site.

For example, an online bookseller called XYZcompany.com may desire to attract new visitors to its web site. XYZcompany.com may thus pay to have award substrates distributed. One or more offline media companies may be engaged to distribute the substrates to potential visitors to the Internet site. For example, XYZcompany.com may pay to have the substrates distributed by a magazine distribution company in its magazines for a particular period of time. Each substrate in XYZcompany.com's promotion may comprise a hidden image and a unique account number. The hidden image may indicate to the recipient one or more awards that the recipient has won when the recipient visits XYZcompany.com's web site and places the substrate over the additive light portion of the site. The substrate may contain the URL for XYZcompany.com's web site and may indicate what awards the recipient may win.

For example XYZcompany.com may provide recipients with one of five different awards: a 5$ coupon, a free book, a free CD, a free bookshelf or a $100 gift certificate for use at the site. Five different images may thus be embedded in different substrates, each image indicating the award. In this example, the images may be words indicating the award or may be a code that corresponds to an award as shown by XYZcompany.com's web site. For example, the codes A-E may be used and XYZcompany.com may indicate that code A means you won a 5$ coupon, etc. By using codes, the award provided to a recipient for a substrate may change periodically or randomly, thus encouraging the recipient to return to the site to determine if a different award has been earned. For example, in one embodiment, a weekly award system may be employed, whereby the award corresponding to a code changes each week.

Through using the present invention, visitors are encouraged to visit Internet company's web site because the hidden award is revealed at that site. Through distribution of these substrates, therefore, a method of attracting visitors to a web site is provided that is more effective than advertising because the offer to win an award provides greater incentive to actually visit the site than a blanket advertisement.

Further, to redeem the award, the user may be requested to register visitor information with the site. Also, the site may request that visitor registration information be provided allowing the recipient to proceed to the page within the web site where the award revealing portion is provided. Therefore, even if the visitor decides not to redeem the award, visitor information has been collected for use in subsequent analysis regarding the effectiveness of the distribution in drawing visitors to that Internet site.

With the visitor information collected (including the unique account number of the substrate that the visitor received), the method of the present invention enables tracking of the effectiveness of various avenues of distribution because the unique account numbers provided on the substrates are entered by the visitors. Therefore, the unique account numbers that are input may be considered to be effective and those that are not may be considered to be ineffective. The distribution channel by which the various unique account numbers were sent may then be analyzed using the visitor information and the visit information as described in greater detail below.

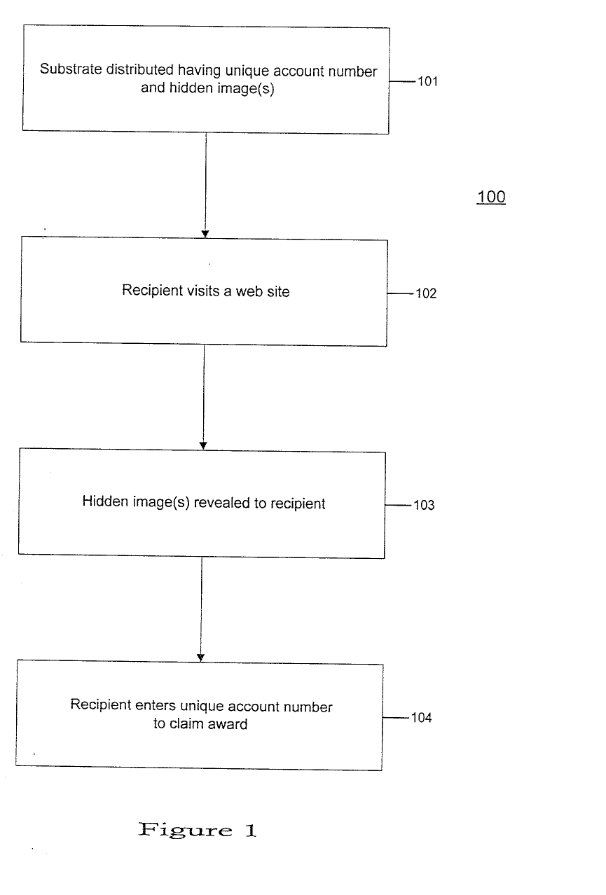

FIG. 1 depicts a flow diagram of a method 100 of attracting visitors using offline distribution channels to an online system, such as an Internet site. At step 101, a plurality of substrates are distributed, each substrate having a unique account number and at least one hidden image. In an embodiment, a single image may be provided on each substrate, although a substrate may also include a plurality of hidden images. The substrates may be distributed in offline media, such as magazines, direct mail, free-standing inserts (FSIs), catalogs, point-of-sale, on and in consumer packaging, compact disks, audio tapes, books, and other offline media. In one embodiment, a compact disk may serve as the substrate, and the hidden image may be printed directly on a side of the disk.

The substrates may be any material that allows a hidden image to be revealed. In various embodiments, the substrate may be a transparent or highly translucent material, such as a decoder as disclosed in U.S. Pat. No. 5,984,367, which is incorporated herein by reference. Also, the unique account number may be labeled a “player's account number.” Additionally, the substrate may be a compact disk, a carrier containing a partially translucent material and a partially opaque material, or other device associated with an online content provider that enables a hidden image to be revealed with the addition of a low-powered light source. Online content providers include web sites and other user-interactive content, goods and services sources. The system may include substrates that reveal a hidden image through the use of additive light sources and other revealing techniques. For example, an additive light source substrate may also be able to reveal the same or a different message by acting as a filter, by completing a partial image, by being viewed in conjunction with another substrate, or by other techniques. These techniques are discussed further below.

In step 102, a recipient of the substrate may visit a predetermined portion of a web site in order to reveal at least one of the hidden images. For example, the recipient may place the substrate in front of a computer monitor displaying the predetermined portion of a web site in order to reveal a hidden image provided in an otherwise concealed portion of the substrate as described in detail in the '357 Patent. Additionally, the system may be implemented by using any light output device, including laptops computers, personal digital assistants (PDAs), stand-alone units, or other light sources.

In step 103, at least one hidden image may be revealed to the recipient. For example, if the hidden image is revealed by placing the substrate in front of an additive light source having a predetermined color, the recipient may visit a predetermined web page, place the substrate in front of a computer output device, and reveal a hidden image. A hidden image may be a coupon for a percentage or dollar amount off the purchase of goods and/or services from an online or offline good or service provider. The hidden image additionally may be a cash or credit voucher which may be redeemed without the purchase of any product or service, such as a sweepstakes prize. The message may comprise an offer for a free good or service. The hidden image may comprise a password or other secret information that a prospect may use to access a web site or physical location. Additionally, the hidden image may be an instruction to visit another online or offline destination in order to continue the pursuit of an award. The hidden image may also have a different nature or be a combination of the above. Moreover, if multiple hidden images are provided on a substrate, each hidden image may represent a different award that may be revealed to the recipient in step 103.

In step 104, the recipient may enter the unique account number that is associated with the particular substrate. In a preferred embodiment, the system may provide immediate confirmation of the award. That confirmation may be based on comparing a unique account number to a database where awards associated with each substrate are stored. This process helps to reduce the likelihood of fraudulent claims of awards. In this step, the user may then be forwarded to a portion of the web site that enables the recipient to utilize the award. For example, if the award is a $100 gift certificate, then the user may be forwarded to a portion of the site to enable to use the gift certificate to make purchases from that online provider (e.g., purchasing books in the XYZCompany.com example).

The system may also request additional information prior to confirming the award. For example, the system may request registration information including the prospect's name, email address, and other personal information. In another embodiment, the registration information may be requested prior to the system providing the revealing screen. For example, a user may be able to access a web page having a revealing screen only after providing registration information. Each of these steps is described in greater detail below.

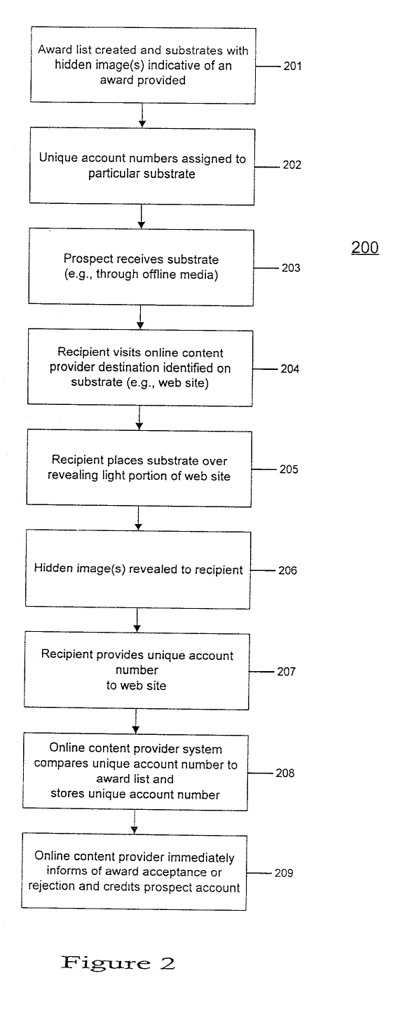

FIG. 2 is a flow chart depicting a method for attracting visitors to Internet sites using hidden award substrates. The successful transformation of a prospect into an online viewer may be called an acquisition. The cost associated with an acquisition may be called an acquisition cost. Acquisition cost includes the financial and non-financial resources that are dedicated by the content providers as well as the participating intermediaries and the development company. Acquisition efficiency may be represented as the number of acquisitions divided by acquisition cost. Use of a method according to the present invention enables an online system to determine and monitor which methods of offline distribution maximize acquisition efficiency.

A method 200 may be provided. In method 200, the online content provider may create an award list in for various unique account numbers step 201. The length of the unique account number may be adjusted (e.g., in accordance with the industry needs and the value of the possible awards). For example, a high value award may have a long unique account number in order to decrease the likelihood of fraudulent claims, while a promotional award may have a short unique account number to minimize prospect data entry. The account number may also be provided in a computer readable format, such as printed on the substrate as a bar code or burned on to a compact disk as a series of numbers and/or letters.

The award list may be stored on a data source operatively associated with the web page provided by the online content provider, referred to hereinafter as the data source. For example, the data source may be a SQL Server database having an Active Server Pages interface. In one embodiment, the development company may provide the technical infrastructure to create, store and manage the award list on behalf of the intermediaries and content providers. Also, another entity may maintain the data source for all or some of the other entities, or each entity may maintain its own data source. Additionally, an intermediary may provide the online content provider with recommendations regarding various award list options, including pre-packaged award lists that may be modified for the online content provider's unique needs. In this step, substrates may be provided that include a hidden image. That hidden image may indicate a corresponding award provided in the award list. For example, if the award list includes fifty different awards, then fifty different types of substrates may be created, each type having a particular hidden image provided.

In step 202, each substrate is provided with a unique account number according to the award list. For example, a sample award list may look as depicted below:

| Award | Unique Account Numbers |
|---|---|
| $5 Coupon | Ending in 0, 1, 8 or 9 |
| Free Book | Ending in 2 or 3 |
| Free CD | Ending in 4-6 |
| Free Bookshelf | Ending in 07, 17, 27, 37, 47, 57, |
| | 67, or 87 |
| $100 Gift Certificate | Ending in 97 |

The substrates having hidden images corresponding to the awards in the award list are provided with appropriate unique account numbers corresponding to the award list. In one embodiment, the substrate may have the unique account number printed directly on it. The unique account number may be placed on a side of a substrate that is visible to a prospect upon opening the media, such as the front of a substrate placed on a carrier inside a magazine. Additionally, the unique account number may be placed on the back of the substrate so that it may not be viewed by a prospect without removing the substrate from a fixed position on the carrier. Also, the substrate may be placed inside a sealed envelope or container so that the unique account may not be viewed by the prospect without opening the envelope or container. For example, the substrate may be placed inside a sealed envelope within a book. Additionally, the substrate may be placed within a sealed compact disk case.

The unique account number also may be associated with a particular offline content provider. For example, if an online content provider distributes substrates through three offline content providers, the online content provider may establish that account numbers starting with 1 are distributed through magazine 1, account numbers starting with 2 are distributed through FSI 2, and account numbers starting with 3 are distributed through cereal box 3. In that way, when a prospect enters the unique account number 365429, the online content provider knows that the substrate was distributed on a cereal box.

In step 203, a prospect receives a substrate through some form of offline media. The substrate may include a statement regarding the possible and/or guaranteed awards available to the prospect by viewing a particular web site. In a preferred embodiment, the web site may have the web site uniform resource locator (URL) and the unique account number printed on the substrate. In this way, the substrate may be removed from the offline media and carried with the prospect until it is used in accordance with the present invention.

In step 204, the recipient of the substrate may visit a portion of a web site associated with an online content provider. For example, the prospect may visit www.xyz.com or www.xyz.com/promotion/ in accordance with the present invention. At step 205, the prospect may place the substrate over a revealing light portion of the web site. The revealing screen may comprise a portion of a web site with a predetermined color designed to provide the additive light source that reveals the hidden image. As described above, the revealing screen may be used independently or in conjunction with other hidden image revealing techniques. For example, the substrate may additionally serve as a filter device that may be placed in front of a filtering screen to reveal a hidden image through light filtration.

In step 206, one or more of the hidden images in the substrate may be revealed to the prospect. This step may include a number of different steps. For example, a user may first place the substrate over a revealing screen on a computer monitor and additional instructions may be revealed. These additional instructions may include an instruction to place the substrate over another screen called a filterable screen. A filterable screen may include a hidden image that may be revealed by placing a filter, such as a substrate, over the filterable screen. The additional instructions may also include different instructions entirely.

In step 207, the recipient of the substrate may provide the unique account number to the system. For example, if the revealing screen is associated with a web page, then the prospect may select a link that states “click here to claim your prize” or select another graphical indicator. In response to the prospect's input, another web page or pop-up window may be displayed that requests information from the recipient including visitor information. The visitor information may include information about the visitor/recipient including, e.g., the unique account number, personal information about the recipient such as name, address, phone, other personal information (e.g., salary range, education level, marital status, gender, etc.), other types of information (e.g., name of offline periodical through which substrate was received, whether the visitor had been to the site before, preferences, etc.), or any combination thereof. As described above, the order in which the account number is requested may be modified so that the account number is requested prior to revealing a web page, such as a web page containing the revealing screen. Additionally, the account number may be requested prior to providing a revealing screen and the personal information may be requested after providing the revealing image.

In step 208, the data source may be queried based upon the user input. Specifically, the data source may compare the unique account number input by the recipient with the award list to determine whether the unique account number matches a unique account number on the award list and whether the award associated with the unique account number has already been claimed. If the unique account number does not appear on the award list or if it has already been claimed, an error message may be presented to the prospect. A prospect may be provided with a limited number of attempts to enter a unique account number, such as three attempts, in order to reduce the likelihood of fraudulent claims being made on the system. Furthermore, as stated previously, the unique account number may be provided on the substrate in computer readable form.

If a unique account number is entered that matches a unique account number on the award list that has not been previously claimed from that site, the system may store the unique account number as a claimed account number and proceed to step 209. Additionally, the system may be modified to allow a limited number of repeat awards for a unique account number. For example, if an online content provider has a half-off promotional, the online content provider may allow two prospects to claim the award for a given unique account number. A third prospect attempting to claim the prize under the same unique account number may be rejected. In this way, the system may account for errors in prospect data entry without enabling unlimited use of a particular unique account number.

In step 209, the system may provide immediate feedback to the prospect regarding confirmation of the award. For example, the system may provide an indication of the award, directions on redeeming the award, rules governing the redemption of the award, or other instructions. In one embodiment, step 209 may also include a modification of a prospect account. For example, if the prospect has an account that is associated with the online content provider, the account may be updated to reflect the award.

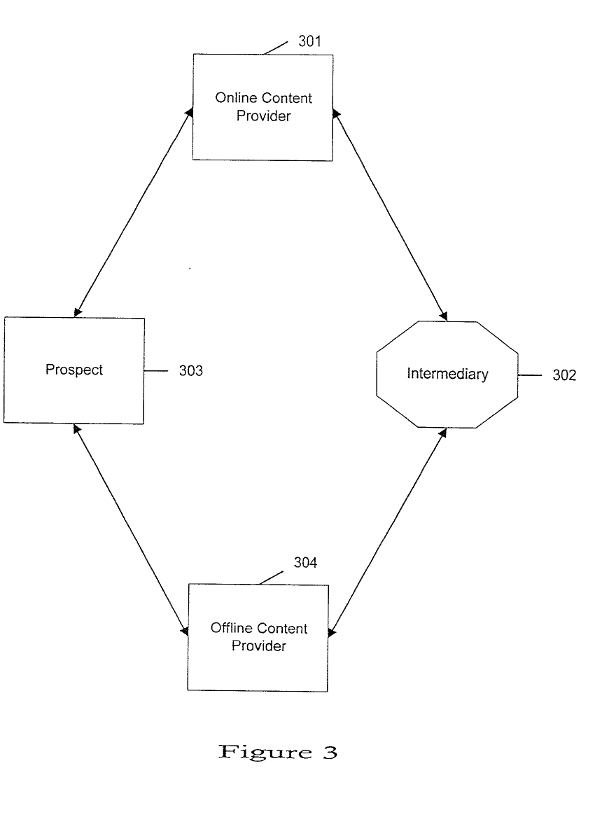

FIG. 3 is a block diagram representing an embodiment of the relationships between various participants in a method of the present invention. In this embodiment, the participants may include one or more intermediaries, one or more online providers, one or more content providers, and a plurality of prospects. The online content provider 301 may be an Internet company, a non-Internet company having an Internet address, or other type of online organization that desires to have visitors to its web site. The online content provider may distribute information for free in exchange for marketing revenue or recognition, or the online content provider may sell or trade goods or services or perform other online activities.

Offline content providers 304 may provide any form of offline content, including magazines, direct mail, free-standing inserts (FSIs), catalogs, point-of-sale, on and in consumer packaging, compact disks, and other offline media.

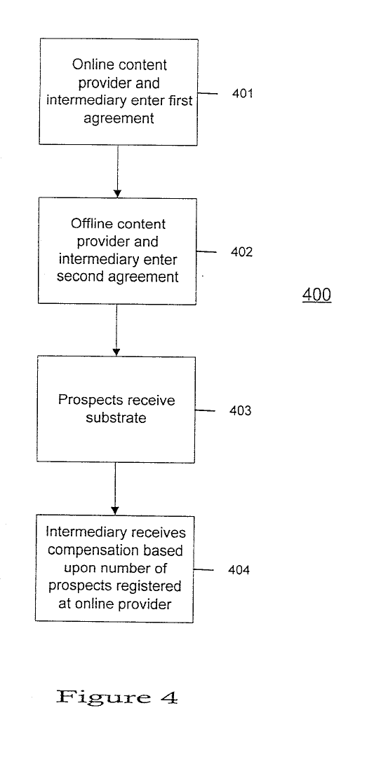

A prospect may be any entity that receives offline content, such as an individual, an organization, a household, or other entity. An intermediary may be any entity that facilitates the application of offline to online technology to a particular industry. Specifically, the intermediary may be a service provider that is familiar with both the online content provider 301 and the offline content provider 304 in a particular industry. In this way, the intermediary may identify opportunities that are unique to a given industry. For example, if an intermediary determines that the acquisition costs in a given industry are particularly high, and that these costs may be reduced by integrating a technology developed by and licensed from a technology company, the intermediary may establish agreements between each of the parties in order to create an economically efficient business model. This process is described more fully below in relation to FIG. 4.

FIG. 4 is a flow diagram of a back-end revenue model in accordance with an embodiment of the present invention. In this method 400, in step 401, the online content provider and the intermediary may enter an agreement. For example, the online content provider and the intermediary may enter an agreement on a traditional fee for service basis, on a back-end revenue model, or based upon another business model.

The back-end revenue model may comprise a first agreement in which the intermediary and the online content provider establish a risk and reward allocation plan that provides both parties with an incentive to perform in a mutually beneficial manner. For example, the back-end revenue model may include an agreement whereby the intermediary initially pays the up-front costs associated with the development and licensing of offline to online technology. The agreement may also include a provision whereby the online content provider pays the intermediary a predetermined fee for each prospect that registers and/or provides the unique account number. Additionally, the agreement may include a provision whereby the online content provider pays a variable per acquisition cost. For example, the online content provider may pay a first fee per acquisition until a first acquisition rate has occurred. Thereafter, the online content provider may pay a second fee per acquisition until a second acquisition rate has occurred. Any acquisition rate and fee per acquisition may be used. Also, the fee may be paid based on actual acquisitions. Therefore, the online content provider may pay per acquisition, may pay based on a predetermined amount set by the percentage of acquisitions, may pay based on the volume of revenue generated from visitors from the distribution over a predetermined period of time, may pay based on the number of visits within a predetermined period of time, may pay based on the number of unique visits within a predetermined period of time, or may pay based on any other similar type of arrangements in which the cost of the program is allocated.

The goal is to develop an agreement that appropriately allocates the benefits and risks associated with the transformation of prospects into online consumers. Software and hardware systems may be used to facilitate the creation and management of the agreement.

In step 402, the offline content provider and the intermediary may enter into a second agreement. As with the first agreement, the objective is for the parties to establish a risk and reward allocation plan that provides both parties the incentive to perform in a mutually beneficial manner. For example, the back-end revenue model may include an agreement whereby the online content provider pays the up-front costs charged by the offline content provider. Additionally, the offline content provider may provide a reduced fee in exchange for participation in the fees generated from the acquisitions.

There are three primary categories of risks in the form of costs in the present system: costs charged by the offline content provider, costs charged by the intermediary, and costs charged by the development company. Although there is still the value in offline advertising even when a prospect is not acquired, the back-end revenue model focuses rewards based upon acquisitions. Accordingly, the parties may shift the risks and rewards in any way in order to create a series of business relationships that optimally benefit each of the parties.

Although the above description identifies a first and second agreements, in one embodiment the order in which the agreements are entered may be different. Additionally, in one embodiment the online content provider, the offline content provider and the intermediary may enter a single agreement. Furthermore, in one embodiment, the technology company may deal directly with the content providers instead of using an intermediary. Also, additional entities may be involved in the present back-end revenue model, include financial services entities, venture capital firms, accounting firms, legal firms, consulting firms, and other entities. For example, a financial services firm may pay various fees on behalf of an intermediary in exchange for an equity interest in the back-end revenue.

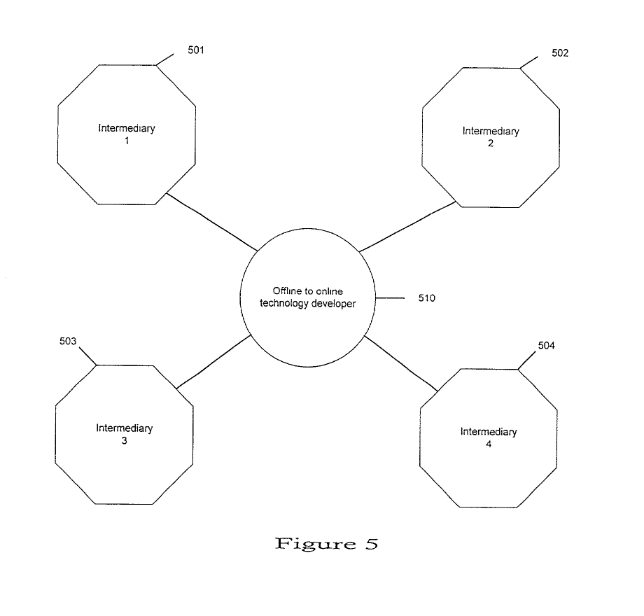

FIG. 5 depicts a block diagram representing the relationships between an offline to online technology development company, or development company 510, and a plurality of intermediaries 501-504. In a preferred embodiment, the intermediaries 501-504 may cater to different industries, different geographies, different sizes of companies, or other business segments. In one embodiment, the development firm 510 may establish exclusive licensing of its technology, including hardware, software, and other systems designed to transform prospects into online viewers. The scope of the exclusive license may be dependent upon the amount of an initial licensing fee. Additionally, the scope of the exclusive license may be dependent upon other factors, such as the reputation of the intermediary, the degree of acceptance of development company technology in the industry, intermediary contacts in the industry, and other factors.

In a preferred embodiment, the development company may provide fundamental technologies designed to decrease the cost of acquisition. As offline distribution technologies, such as new types of substrates or other offline distribution technologies, are developed, the development company may also develop the hardware and software systems needed to support the effective implementation of the offline distribution technologies. For example, the development company may develop the back-end databases and database interfaces that are needed to create and manage the award list. Additionally, the development company may provide access to and maintain the accounting, taxation, logistics, and other software on behalf of the intermediaries and content providers. Also, the development company may enter an agreement with an application service provider in order to provide the accounting, taxation, logistics, and other software for the benefit of each of the entities. Other software and hardware systems may also be developed.

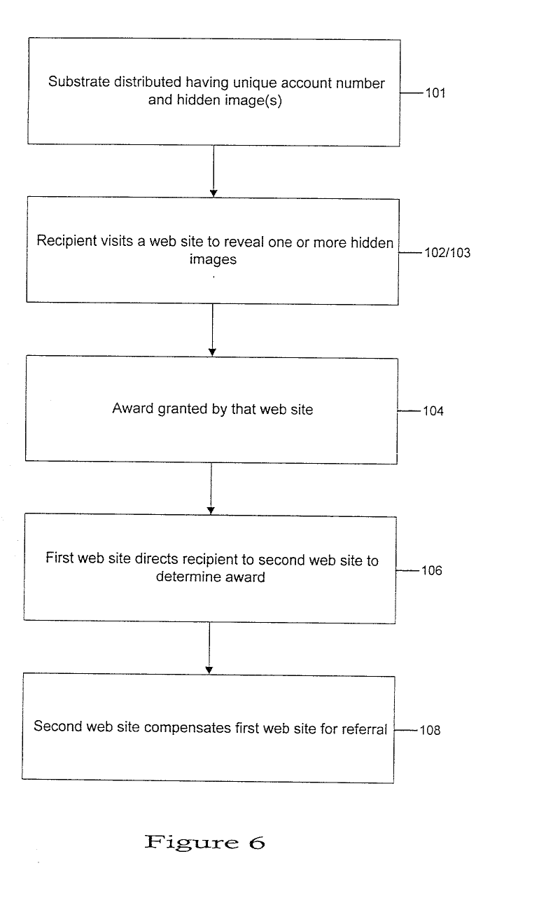

It may also be desired that multiple online providers participate in the method of the present invention to share revenues and costs of this system. Specifically, a method of referrals may be provided whereby a substrate may be used at more than one site to claim one or more rewards at each site. The site receiving an acquisition from this referral may agree to pay a predetermined fee to the referring site. Such a method is depicted in FIG. 6. Steps 101-104 may be performed as described above. Additionally, in step 106, the first web site may, upon completion of an award claim, registration or other step, provide a link to the recipient of the substrate to another site where the substrate may provide an award. In this embodiment, a single hidden image may be provided, or separate hidden images for each referred web site may be provided. Then in step 108, the second site may be compensated for the referral. In step 108, other exchanges may also be made. Indeed, the second site may similarly refer recipients to the first site and those referrals may be used. Also, the second site may provide advertising or some other form of retribution in exchange for the referral.

In addition, many different sites may enter into an arrangement to transfer the recipient of a substrate within those participating sites. A web-ring or web-mesh type of arrangement may be provided whereby each site refers a recipient to another predetermined site where the recipient's substrate may be used to claim an award or potential award. The members of this arrangement may then share in the costs.

According to another embodiment, a single substrate may indicate the various participating sites where the substrate may be used to claim an award. A method 700 according to this embodiment may be provided. In step 702, the substrate is distributed having unique account number, hidden image(s) and a plurality of participating online providers depicted thereon. In step 704, the recipient visits one or more of the participating online providers to claim an award. If a single hidden image is used, that hidden image may be used to determine an award at one or more of the sites. In an embodiment, the recipient may be able to claim an award from each participating site. In another embodiment, the recipient may be limited to claiming an award from one or another predetermined number of participating sites. Also, the substrate may provide multiple hidden images, each hidden image corresponding to a different participating site. Also, a starting point site may be provided where the user may determine the awards offered at the participating site. For example, a main site may reveal the award for a hidden image and indicate what prizes are offered at each of the various participating sites for that award. A participating bookseller may offer a free book, whereas a participating clothing retail may offer a $10 off coupon. In this manner, the user may choose where to redeem the award, or may visit several or all of the participating sites to redeem the awards that the recipient desires. In step 706, the cost of distribution and benefits may be allocated by participating online providers on a predetermined basis. In this embodiment, participating members may share the costs evenly or may allocate the costs based on the effectiveness of the distribution for that site. For example, if companies participate and the cost is $10,000, the companies could each pay $2000 each or could pay according to the number of hits the company received as a fraction of the total hits generated from the distribution. If one company got three times as many hits than another, then that company would carry the higher percentage of the costs. Other cost and fee sharing arrangements may be made as well.

According to another embodiment of the present invention, a method 800 for attracting repeat visitors is provided. In this method, the awards change over time either randomly or according to a predetermined schedule. Therefore, the recipient of the substrate is encouraged to return frequently to see if any different awards have been provided for that substrate's hidden image. Further, a predetermined schedule may be established whereby the recipient knows when to return to see if additional and/or different awards are provided. The schedule may be hourly, daily, weekly, monthly or any other time period. Further, the award may be in addition to that already offered or may comprise a different award. For example, a particular hidden image revealed on the site may indicate that the award is a $5 coupon one week. The next week, the same image may correspond to a free book. Therefore, the system may enable the user to claim both awards, or may limit the user to a single award that the recipient determines when to “claim.” Either way, the system provides an incentive for the recipient to return to the site multiple times.

In method 800, step 101 is performed as described above. In step 802, an award schedule based on the image is created. That award schedule may be modified as the award program continues. For example, when the program begins, the awards may be fixed, but when the program continues, those awards may be modified. The schedule may include the times and/or dates when the awards change. In step 804, the recipient is notified of the award schedule so the recipient knows when to return to the site to claim an award. That notification may be provided directly on the substrate or in information associated with the substrate. That schedule may also be posted on the online site where the user is directed to determine the award. For example, the site may indicate that the user has won a free book this week, but that the user can check back next week to see if they have won any additional or different awards. In step 806, the recipient may visit the site according to the award schedule to check for new/different awards. In step 808, the revenue is allocated based on the visitation schedule by recipients. In one example, a fee may be paid for each visit by the recipient. Other cost/revenue allocation methods may be used taking into consideration the number of times various recipients visit a site.

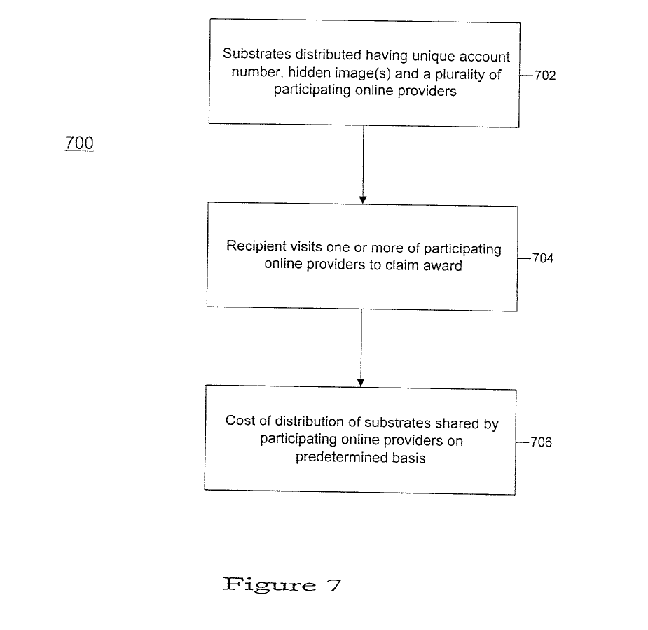

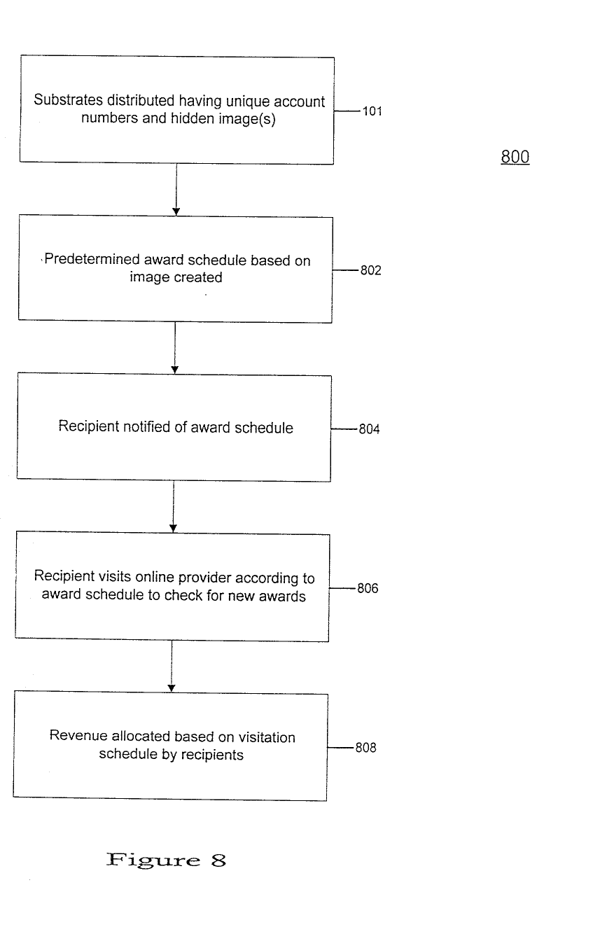

If multiple participants are involved as in the method described with reference to FIG. 7, different schedules may be provided for each participant in FIG. 8 or the same schedule may be provided. In this example, one participant may change its awards daily, while another changes them monthly.

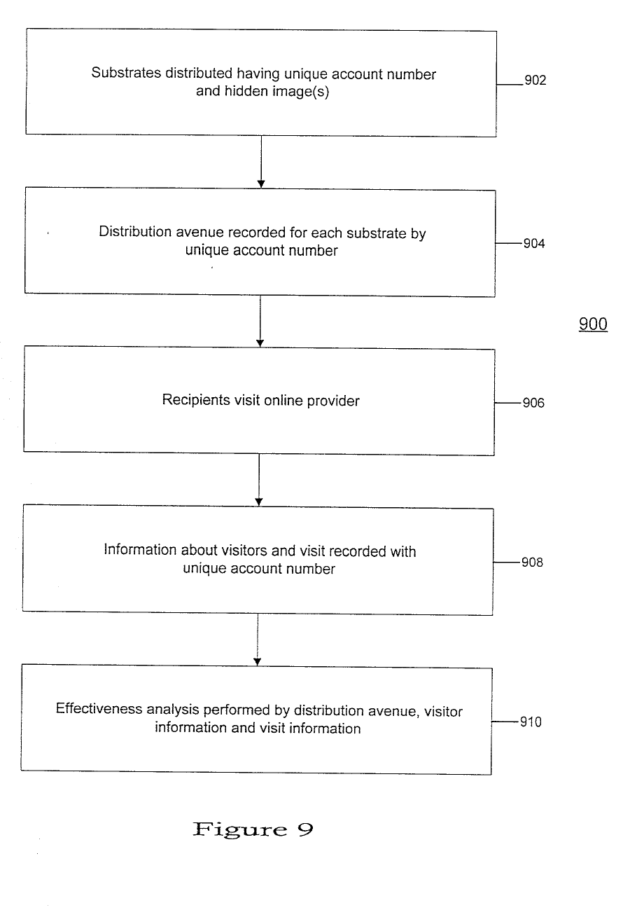

FIG. 9 depicts another embodiment of the present invention in which the effectiveness of the distribution of the substrates may be monitored. A method 900 may be provided according to this embodiment. In method 900, substrates having unique account numbers and hidden image(s) are distributed through an offline media channel as in step 101 above in step 902. In step 904, the distribution avenue for each substrate is recorded and associated in a database with the unique account number. In step 906, the recipients visit an online provider. In step 908, optionally, visitor information and visit information is collected from the recipient as well as the unique account number. That information may be input by the recipient to claim an award. In step 910, the effectiveness of the campaign may be determined using the distribution avenue information, the visitor information and the visit information.

In an embodiment, as described above, the visitor information may include demographic and personal information about the recipient. The visit information may comprise information regarding that visitor's visit(s) to the site. This information may include, but is not limited to the following: time and date of visit(s), number of visits, result of visit (e.g.,. purchase of goods, x number of page views, link to another site, clicked on x number of advertisements, etc.), length of visit (e.g., number of page views, time spent between page views, etc.) and other information.. Step 910 may involve a number of different types of analysis that is available based on this information. For example, the online content provider may desire to know the most effective distribution avenue to reach 18-35 year olds. Further, the online content provider may desire to know which recipients are most likely to become consumers to target the distribution channels to those recipients. Step 910 may be performed using data mining techniques based on this database of information that is available. Through these data mining techniques, the value of this method is maximized. One of ordinary skill in the art will appreciate the various data mining techniques that may be employed from the information recorded.

Although many of these embodiments are depicts in separate figures, it should be understood that combinations of these techniques are intended. Indeed, the steps in FIG. 9 may be performed as part of the embodiments of any of FIGS. 1-8. Similarly, all other methods depicts should be understood to be usable in combination with any other method described.

While the invention has been particularly shown and described with reference to a number of embodiments, it will be understood by those skilled in the art that various other changes in the form and details may be made therein without departing from the scope of the invention. The scope of the invention should be determined by the appended claims and their legal equivalents, rather than by the examples given.

What is claimed:

1. A method for attracting visitors to an online site through offline distribution avenues comprising the steps of:
distributing a plurality of substrates, wherein each substrate comprises a unique account number and at least one hidden image;
directing recipients of the substrates to one or more online site participants, each online site participant providing at least one revealing screen that reveals one or more awards from the hidden image when the one or more hidden images are placed in front of the revealing screen; and
accepting recipient information including at least the unique account number of the substrate.

2. The method of claim 1 wherein at least one of the hidden images reveals a plurality of awards.

3. The method of claim 2 wherein each award is redeemable at a single online site participant.

4. The method of claim 1 wherein one or more of the online site participants provides a link to one or more other online site participants.

5. The method of claim 4 wherein online site participants allocate costs or benefits based on links within those participants.

6. The method of claim 1 wherein an online site participant includes a hub participant to which a recipient is directed and wherein the hub participant provides a revealing screen that reveals one or more awards that are available at a plurality of online site participants.

7. The method of claim 1 further comprising the steps of:
creating a predetermined award schedule that determines when the awards corresponding to hidden images in the substrates change;
providing the predetermined award schedule to recipients of the substrates; and
providing a revealing screen that reveals an award associated with a substrate according to the predetermined award schedule to thereby attract the user back to the online site participant.

8. The method of claim 7 wherein the recipient may redeem additional awards as the award changes for that recipient's substrate.

9. The method of claim 1 further comprising the step of changing the award associated with a hidden image randomly to encourage a recipient to return to the online site participant to determine how the award has changed.

10. The method of claim 1 wherein the unique account number is entered prior to presenting the revealing screen to the recipient.

11. The method of claim 1 further comprising the step of enabling the user to redeem the award at one or more of the online site participants.

12. The method of claim 1 further comprising the step of receiving registration information from the user.

13. The method of claim 1 further comprising the step of recording visit information regarding the recipient's visit to an online site participant.

14. The method of claim 1 further comprising the steps of:
distributing the substrates through a plurality of distribution channels;
recording unique account numbers and the corresponding distribution channels for the substrates;
analyzing the effectiveness of a distribution channel using the unique account numbers entered by recipients at the online site participants when those recipients visit the online site participants to determine the award corresponding to the hidden image.

15. The method of claim 14 wherein the analyzing step includes visitor information and visit information to determine the effectiveness of a distribution channel at attracting different visitors and visits.

16. The method of claim 1 wherein the method involves substrate creators and intermediaries in addition to the online site participants and wherein the participants allocate costs or benefits between them.

17. The method of claim 16 wherein the allocation is based at least in part on a fixed fee.

18. The method of claim 17 wherein the allocation is based on the effectiveness of the distribution.

19. A method for encouraging input of visitor information at an online site comprising the steps of:
providing at least one revealing screen from that online site that reveals one or more awards when a user places a hidden-image substrate in front of the revealing screen; and
providing a visitor information input page to the user; and
receiving input of specified visitor information prior to enabling the user to visit one or more protected screens at the online site.

20. The method of claim 19 wherein the one or more protected screens includes the revealing screen.

21. The method of claim 19 wherein the one or more protected screens includes a screen where one or more awards may be redeemed.

22. The method of claim 19 wherein the one or more protected screens includes a screen where one or more awards may be received.

23. The method of claim 19 further comprising the steps of providing a revealing screen that reveals an award associated with a substrate according to the predetermined award schedule to thereby attract the user back to the online site participant.

24. The method of claim 23 wherein the recipient may redeem additional awards as the award changes for that recipient's substrate and wherein the user must input visitor information prior to each redemption.

25. The method of claim 19 wherein the visitor information comprises a user name and password.

26. The method of claim 19 wherein the visitor information comprises user identifying information.

27. The method of claim 19 further comprising the step of changing the award associated with hidden image randomly to encourage a recipient to return to the online site participant to determine how the award has changed.

28. The method of claim 19 wherein the visitor information comprises the unique account number of the substrate.

29. A system for attracting visitors to an online site through offline distribution avenues comprising:
distribution means for distributing a plurality of substrates, wherein each substrate comprises a unique account number and at least one hidden image;
directing means for directing recipients of the substrates to one or more online site participants;
one or more online site participants that provide at least one revealing screen that reveals one or more awards from the hidden image when the one or more hidden images are placed in front of the revealing screen; and
account number accepting means for accepting recipient information including at least the unique account number of the substrate.

30. The system of claim 28 wherein at least one of the hidden images reveals a plurality of awards.

31. The system of claim 29 wherein each award is redeemable at a single online site participant.

32. The system of claim 28 wherein one or more of the online site participants provides a link to one or more other online site participants.

33. The system of claim 31 wherein online site participants allocate costs or benefits based on links within those participants.

34. The system of claim 33 wherein one of the online site participants comprises a hub participant to which a recipient is directed and wherein the hub participant provides a revealing screen that reveals one or more awards that are available at a plurality of online site participants.

35. The system of claim 28 further comprising:
schedule means for storing a predetermined award schedule that determines when the awards corresponding to hidden images in the substrates change; and
wherein the revealing screen reveals an award associated with a substrate according to the predetermined award schedule to thereby attract the user back to the online site participant.

36. The system of claim 28 further comprising award changing means for changing the award associated with a hidden image randomly to encourage a recipient to return to the online site participant to determine how the award has changed.

37. The system of claim 28 further comprising visitor information input means for enabling users to input visitor information.

38. The system of claim 28 further comprising visit recording means for recording visit information about a visitor's visit to the online site participant.

39. The system of claim 28 further comprising analysis means for analyzing the effectiveness of a substrate distribution using the unique account numbers entered by recipients at the online site participants when those recipients visit the online site participants to determine the award corresponding to the hidden image.

40. A server system for encouraging input of visitor information from visitors to that server system that receive files from the server system over the Internet comprising:
visitor information input means for interacting with a visitor to receive visitor information from the user; and
revealing screen means, interacting with the visitor information input means, for presenting at least one revealing screen to the visitor that reveals one or more awards; and
screen control means for limiting a visitor's access to specified content of the server system until the visitor information has been received.

41. The system of claim 40 wherein the specified content includes one or more revealing screens.

42. The system of claim 40 wherein the specified content includes a screen where one or more awards may be redeemed.

43. The system of claim 40 wherein the specified content includes a screen where one or more awards may be received.
